(19) United States
(12) Patent Application Publication
(10) Pub. No.: US 2026/0115624 A1
(43) Pub. Date: Apr. 30, 2026

(54) GAS PURIFICATION SYSTEM

(71) Applicant: HIGHLIGHT TECH CORP., Tainan City (TW)

(72) Inventors: CHWUNG-SHAN KOU, Tainan City (TW); CHIEN-HSUN CHEN, Tainan City (TW); TSUN-LIANG KUO, Tainan City (TW); SZU-MIN LIN, Tainan City (TW); HONG-SHENG FANG, Tainan City (TW)

(73) Assignee: HIGHLIGHT TECH CORP., Tainan City (TW)

(21) Appl. No.: 18/932,242

(22) Filed: Oct. 30, 2024

(51) Int. Cl. B01D 5/00; B01D 53/00

(52) U.S. Cl. CPC B01D 5/0069; B01D 5/0051; B01D 5/0081; B01D 53/002; B01D 2257/706; B01D 2259/806

(57) ABSTRACT

A gas purification system with a water tank, a reaction cavity, a condensation trap device and a dust collection chamber is disclosed. The reaction cavity uses a negative pressure suction to transport a water vapor and a gas to be processed into the reaction cavity, the gas to be processed at least contains a waste gas that can react with the water vapor, so that the water vapor contacts the waste gas in the gas to be processed and performs a reaction to obtain at least one product. The condensation trap device performs a condensation capture processing and a centrifugal separation processing on the product. The dust collection chamber is used to collect the product thrown out by centrifugal force and/or dropped by gravity.

### BACKGROUND OF THE DISCLOSURE

### 1. Field of Disclosure

The disclosure relates to a semiconductor processing system, and more particularly to a gas purification system.

### 2. Related Art

The production process of semiconductors uses a large amount of flammable, corrosive or highly toxic reactive gases. However, the utilization rate of reactive gases in many semiconductor manufacturing processes is very low. Therefore, the residual gases and reaction product that are not completely reacted during the manufacturing process must be discharged from the reaction process chamber. These mixed gases (generally called tail gases) must be converted into harmless or treatable substances before they can be discharged.

The current waste gas system mainly consists of a turbo pump, a mechanical pump and a local scrubber system connected to the reaction process chamber. The tail gases are extracted from the reaction process chamber through the turbo pump, exhaust pipeline and mechanical pump sequentially, and sent to the local scrubber system for processing, and then sent to the central scrubber system for discharge.

In order to properly handle tail gases, many techniques have been proposed and used. For example, there is currently an existing technique that uses an air extraction pump to discharge the tail gases to a combustion scrubber tower for tail gas processing before discharging the process waste gas. However, the combustion scrubber tower is not very effective in processing fluorine compounds, and must be kept in operation at all times to provide a large amount of fuel gas. Therefore, the cost increases significantly and a lot of energy is consumed. The fuel gas is a flammable and explosive gas, which will increase public security risks. In addition, although there is another existing technique that uses the catalyst thermal cracking method, the catalyst will have aging and poisoning problems, and the cost of catalyst replacement and recycling is quite high. However, the catalytic thermal cracking method also needs to be kept running at all times and also consumes a lot of energy.

In addition, although there are techniques available that use plasma torch scrubber towers for tail gas processing. Plasma has been proven to be effective in decomposing tail gases, especially for perfluorinated compounds (PFCs) that require high temperature processing. However, plasma operates under air pressure and consumes a lot of energy. At the same time, because the plasma temperature exceeds thousands of degrees, the system components are not only expensive but also have a short service life. In particular, the stability of atmospheric plasma is poor. It is easy to cause plasma extinguishment due to changes in operating conditions.

On the other hand, there are theoretical techniques that propose installing a plasma treatment device in front of the mechanical pump to treat tail gases under low air pressure. The results show that because the electron energy at low air pressure is high, it can effectively dissociate tail gases. Although the processing effect is good, because the plasma treatment device is directly connected to the rear end of the turbine vacuum pump, there is a concern that the gas reactants will flow back and contaminate the manufacturing process. Therefore, it cannot be accepted by the semiconductor manufacturing process and is not currently used.

Most of the existing mechanical pumps adopt a two-stage combination, that is, the first stage is a booster pump and the second stage is a dry pump. The booster pump can accelerate the system to reach a lower air pressure due to its high pumping rate, which facilitates the dry pump in the second stage to achieve operating and setting air pressure. The existing mechanical pump operations have to introduce a large amount of purge gas, such as nitrogen, into the dry pump in the second stage (rear stage) to dilute flammable, corrosive or highly toxic tail gases, and at the same time slow down the problem of pipeline clogging caused by solid particles generated during the manufacturing process. Since the gas flow rate is quite large, a high-power air extraction pump must be used, which virtually increases operating costs and consumes energy. Moreover, a large amount of nitrogen subsequently enters the current local scrubber system such as combustion or thermal reaction scrubber tower, which will produce a large amount of greenhouse gases such as nitrogen oxides (NOx), causing secondary pollution to the environment.

Furthermore, even if a large amount of purge gas is introduced, solid particles will still block the dry pump in the second stage (rear stage) in some manufacturing processes, especially the outlet of the dry pump. This will seriously reduce the pumping efficiency and increase the operating current of the dry pump, which not only increases energy consumption and operating costs, but may even cause damage to the dry pump and cause manufacturing process shutdown.

### SUMMARY OF THE DISCLOSURE

In order to solve the problems of the conventional techniques, an object of the disclosure is to provide a system capable of effectively processing a gas to be processed, and capable of reducing an energy consumption of mechanical pumps and significantly reducing a production volume of greenhouse gases such as nitrogen oxides (NOx), at the same time, capable of effectively solving the problem of solid particle clogging to extend a service life of dry pumps.

In order to achieve the aforementioned object, the disclosure discloses a gas purification system. The gas purification system performs a condensation capture processing and a centrifugal separation processing on a waste gas in a gas to be processed, thereby purifying the gas to be processed, the gas purification system at least comprises: a water tank that stores an aqueous solution used to generate a water vapor; a reaction cavity that uses a negative pressure suction to transport the water vapor and the gas to be processed in the water tank into the reaction cavity, so that the water vapor contacts the waste gas in the gas to be processed and performs a reaction to obtain at least one product; and a condensation trap device communicated to the reaction cavity, the condensation trap device enables the gas to be processed to enter the condensation trap device along a transport direction, so as to perform the condensation capture processing to capture a part of the product carried by the gas to be processed, and then the transport direction of the gas to be processed is changed, so that a remaining part of the product carried by the gas to be processed is captured by preforming the centrifugal separation processing and the condensation capture processing again, and then the gas to be processed undergone the condensation capture processing and the centrifugal separation processing of the condensation trap device is discharged.

Based on the above, the gas purification system of the disclosure has the following advantages. (1) The gas purification system is provided with the reaction cavity that enables the water vapor to react with the gas to be processed to produce the corresponding product. (2) The gas purification system is provided with the condensation trap device capable of capturing the product produced by a reaction between the water vapor and the gas to be processed. (3) The gas purification system is provided with a dust collection chamber capable of collecting the product thrown out by centrifugal force and/or dropped by gravity. (4) The gas purification system is provided with a dust collection box capable of collecting the product. (5) The gas purification system is provided with a microwave generator capable of providing a microwave to assist a reaction between the water vapor and the gas to be processed, and capable of providing an effect of maintaining temperature to prevent premature condensation of the water vapor on a pipe wall. (6) The gas purification system is provided with a flow control valve capable of controlling a supply volume of the water vapor of a water vapor conveying pipe to correspond to a flow rate of the gas to be processed, so that the aqueous solution could be used most efficiently. (7) The gas purification system is provided with a heating element capable of controlling a temperature of the aqueous solution in the water tank to correspond to a flow rate of the gas to be processed, so that the aqueous solution could be used most efficiently. (8) The disclosure could not only effectively process the gas to be processed, but could also reduce an energy consumption of mechanical pumps and significantly reduce a production volume of greenhouse gases such as nitrogen oxides (NOx), at the same time, could effectively solve the problem of solid particle clogging to extend a service life of dry pumps.

In order to enable the examiner to have a further understanding and recognition of the technical features of the disclosure, preferred embodiments in conjunction with detailed explanation are provided as follows.

### BRIEF DESCRIPTION OF THE DRAWINGS

FIG. 1 is a schematic diagram of a gas purification system of the disclosure applied between a gas to be processed generation source and an air extraction pump.

FIG. 2 is a side view of the gas purification system according to a first embodiment of the disclosure.

FIG. 3 is a side view of the gas purification system according to a second embodiment of the disclosure.

FIG. 4 is a perspective view of a microprocessing device added to a reaction cavity of the gas purification system of the disclosure.

FIG. 5 is a cross-sectional view of the reaction cavity shown in FIG. 4.

FIG. 6 is a top view of the reaction cavity shown in FIG. 4.

FIG. 7 is a cross-sectional view of a condensation trap device of the gas purification system of the disclosure.

FIG. 8 is a perspective view of the condensation trap device of the gas purification system of the disclosure.

FIG. 9 is a cross-sectional view of the condensation trap device of the gas purification system of the disclosure, wherein the condensation trap device is optionally provided with a vibrator and/or a baffle.

### DETAILED DESCRIPTION OF THE DISCLOSURE

In order to understand the technical features, content and advantages of the disclosure and its achievable efficacies, the disclosure is described below in detail in conjunction with the figures, and in the form of embodiments, the figures used herein are only for a purpose of schematically supplementing the specification, and may not be true proportions and precise configurations after implementation of the disclosure; and therefore, relationship between the proportions and configurations of the attached figures should not be interpreted to limit the scope of the claims of the disclosure in actual implementation. In addition, in order to facilitate understanding, the same elements in the following embodiments are indicated by the same referenced numbers. And the size and proportions of the components shown in the drawings are for the purpose of explaining the components and their structures only and are not intending to be limiting.

Unless otherwise noted, all terms used in the whole descriptions and claims shall have their common meaning in the related field in the descriptions disclosed herein and in other special descriptions. Some terms used to describe in the present disclosure will be defined below or in other parts of the descriptions as an extra guidance for those skilled in the art to understand the descriptions of the present disclosure.

The terms such as “first”, “second”, “third” and “fourth” used in the descriptions are not indicating an order or sequence, and are not intending to limit the scope of the present disclosure. They are used only for differentiation of components or operations described by the same terms.

Moreover, the terms “comprising”, “including”, “having”, and “with” used in the descriptions are all open terms and have the meaning of “comprising but not limited to”.

A gas purification system of the disclosure is applicable for using a water vapor to capture a gas to be processed discharged from a gas to be processed generation source in a semiconductor process room, capable of effectively capturing and collecting a product generated after a reaction between the water vapor and the gas to be processed, capable of timely observing and removing the product, capable of reducing a reaction activation energy and maintaining a temperature through microwave heating, and capable of preventing the high-temperature gas to be processed from condensing on unexpected locations when encountering coldness, resulting in reduced pumping speed or inability to effectively capture the gas to be processed. The gas to be processed at least contains a waste gas that could react with the water vapor, as long as any gas to be processed or any waste gas contained in it could react with the water vapor, regardless of whether the product generated after a reaction with the water vapor is in solid state, liquid state, gaseous state or combinations thereof, any gas to be processed or any waste gas contained in it is applicable to the disclosure.

In detail, the product obtained by reacting the water vapor with the waste gas contained in the gas to be processed depends on types of the gas to be processed and the waste gas. Although the waste gas contained in the gas to be processed in the disclosure is trimethylaluminum (TMA) as an example, the product obtained by reacting trimethylaluminum (TMA) with the water vapor is solid particle dust and methane gas of aluminum hydroxide and/or aluminum oxide, however the disclosure is not limited thereto. Depending on a process gas used in an actual semiconductor manufacturing process, the product obtained after a reaction between the water vapor and the waste gas contained in the gas to be processed could also be a liquid, a gas or a combination thereof, preferably a non-toxic liquid or gas or a combination thereof.

The gas purification system of the disclosure is applicable for capturing the gas to be processed discharged from a gas to be processed generation source, thereby the gas to be processed could be captured and collected in advance before the gas to be processed is sucked into an air extraction pump, not only could achieve an efficacy of capturing the gas to be processed, but could also maintain a pumping speed of the air extraction pump with minimal impact on a pumping speed in order to avoid reduction of a pumping speed caused by capturing the gas to be processed.

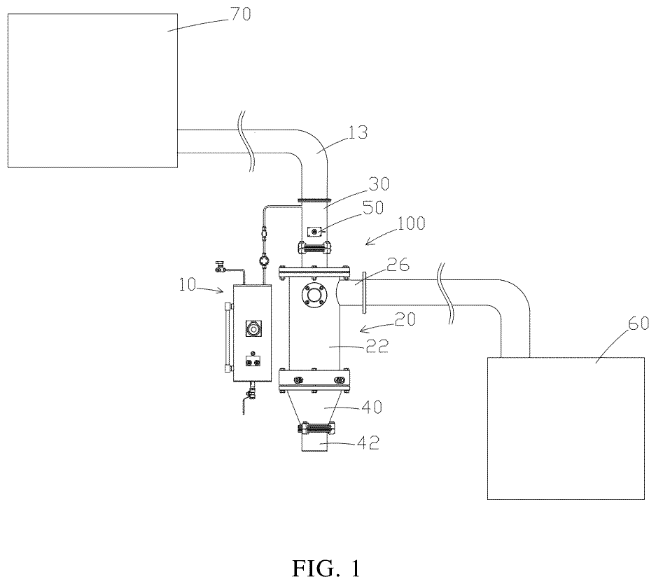

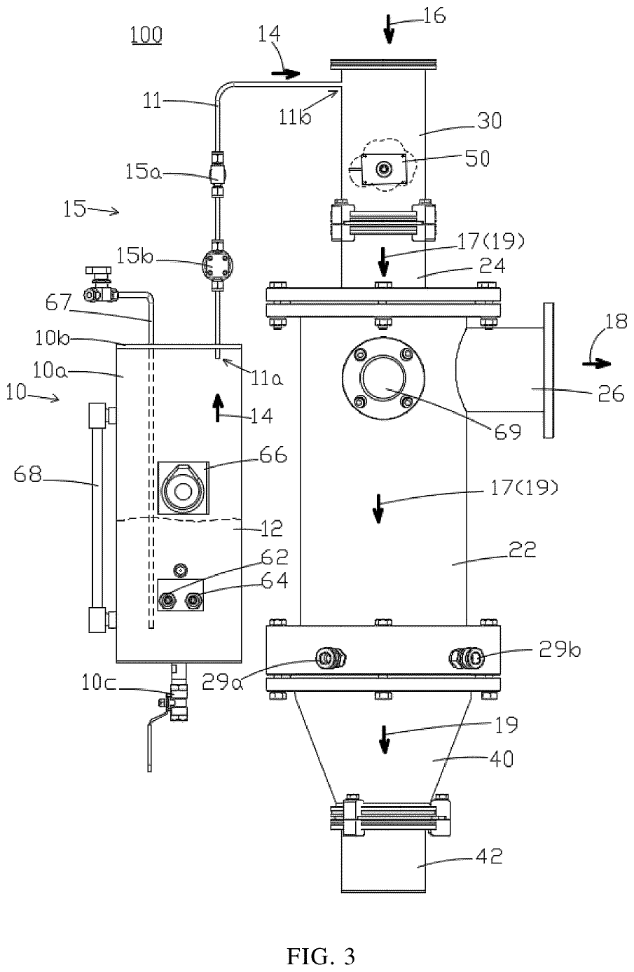

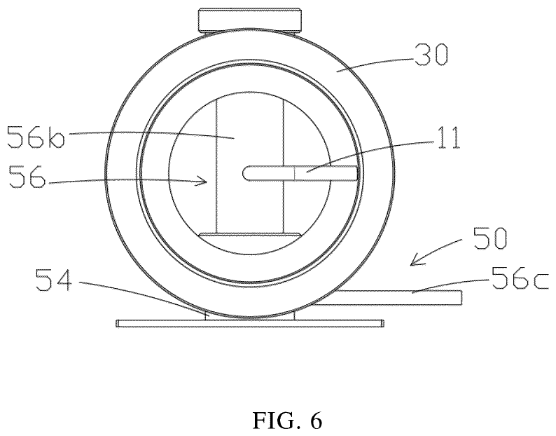

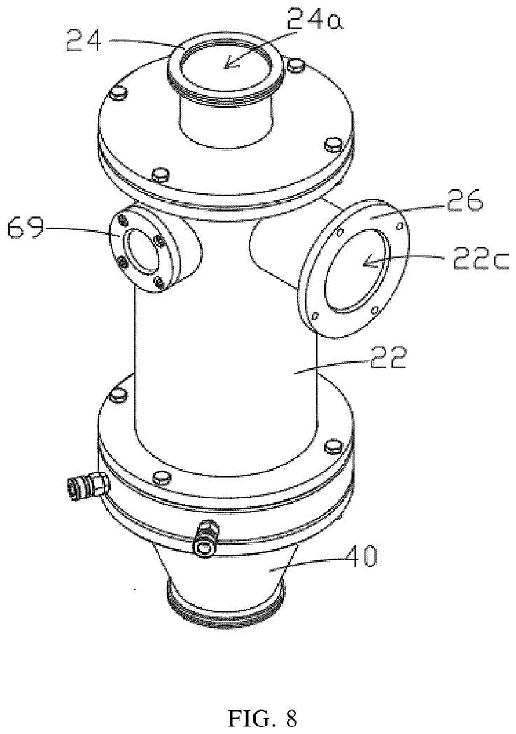

Please refer to FIGS. 1 to 9. In a first embodiment of the disclosure, as shown in FIGS. 1, 2 and 4 to 9, a gas purification system 100 at least comprises a water tank 10, a reaction cavity 30, a condensation trap device 20 and a dust collection chamber 40. The water tank 10 stores an aqueous solution 12 for generating a water vapor 14, and the aqueous solution 12 generates the water vapor 14, for example, through vaporization such as boiling or evaporation. The water tank 10 has a water vapor conveying pipe 11, wherein a water vapor inlet 11a of the water vapor conveying pipe 11 is located above the aqueous solution 12 in the water tank 10, and a water vapor outlet 11b of the water vapor conveying pipe 11 is located in the reaction cavity 30. A gas to be processed 16 in the disclosure is discharged from a gas to be processed generation source 70, wherein a gas conveying pipe 13 is connected between the gas to be processed generation source 70 and the reaction cavity 30, thereby transporting the gas to be processed 16 along a transport direction (e.g., longitudinal, top to bottom) from an inlet of the reaction cavity 30 to an interior of the reaction cavity 30. The gas to be processed generation source 70 is not particularly limited, it could be, for example, a semiconductor process chamber or any source of gas to be processed that could discharge a gas to be processed. Therefore, the gas to be processed 16 applicable to the disclosure is also not particularly limited, as long as the gas to be processed 16 contains any waste gas that could react with the water vapor 14, regardless of a proportion, it could be applicable to the disclosure.

One feature of the disclosure is using a negative pressure suction generated by an air extraction pump 60 to transport the water vapor 14 and the gas to be processed 16 along the transport direction (e.g., longitudinally, from top to bottom) into the reaction cavity 30, wherein the gas to be processed 16 at least contains the waste gas that could generate a reaction with the water vapor 14, so that the water vapor 14 contacts the waste gas in the gas to be processed 16 and performs a reaction to obtain at least one product 19. The air extraction pump 60 is, for example, but not limited to, a dry pump, and a degree of vacuum that the air extraction pump 60 could achieve is not particularly limited, the air extraction pump 60 could, for example, provide a low air pressure environment between 0.01 torr and 10 torr, but is not limited thereto. Since a boiling point of the aqueous solution 12 is directly proportional to a vapor pressure on a liquid surface, that is, the smaller a vapor pressure, the lower a boiling point; another feature of the disclosure is using the air extraction pump 60 to create a low-pressure environment capable of effectively reducing a boiling point of the aqueous solution 12, which helps to reduce a boiling point temperature at which the aqueous solution 12 vaporizes into the water vapor 14; for example, but not limited to, a boiling point temperature of the aqueous solution 12 could be reduced to below about 40 degrees Celsius, preferably between about 30 degrees Celsius and 40 degrees Celsius.

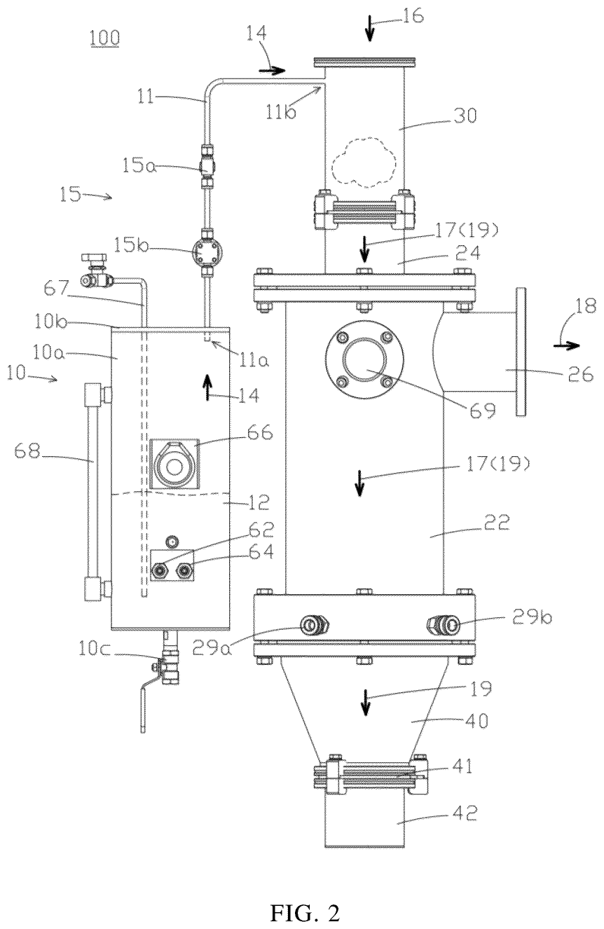

As shown in FIG. 2, the condensation trap device 20 of the gas purification system 100 of the disclosure is connected to the reaction cavity 30. The condensation trap device 20 comprises a first cavity 22, an introduction pipe column 24, an export pipe 26 and a cooling element 28. Wherein the introduction pipe column 24 is penetratingly disposed in a chamber 23 of the first cavity 22 through a top side of the first cavity 22, and extends in a direction of an opening 22b on a bottom side of the first cavity 22, and the chamber 23 of the first cavity 22 is communicated to the reaction cavity 30 through the introduction pipe column 24. The export pipe 26 is disposed on a discharge port 22c of the first cavity 22 and is communicated between the first cavity 22 and the air extraction pump 60. The cooling element 28 is disposed on the chamber 23 of the first cavity 22 and could provide a condensation function to condense and capture a gas to be processed 17 and the product 19 obtained after reacting with the water vapor 14. Furthermore, the condensation trap device 20 discharges a gas to be processed 18 that has undergone a condensation capture processing and a centrifugal separation processing from the discharge port 22c of the first cavity 22. The disclosure takes as an example that the cooling element 28 is disposed in the chamber 23 of the first cavity 22 and wrapped around the introduction pipe column 24; however, the disclosure is not limited thereto. The disclosure could also optionally dispose the cooling element 28 inside the introduction pipe column 24, or dispose on an exterior of the chamber 23 of the first cavity 22. In other words, as long as the cooling element 28 is capable of making the first cavity 22 and/or the introduction pipe column 24 form a condensation surface for performing the condensation capture processing, it is applicable to the disclosure.

In detail, when the air extraction pump 60 is operating, the gas purification system 100 of the disclosure could utilize the negative pressure suction generated by the air extraction pump 60 to transport the water vapor 14 and the gas to be processed 16 into the reaction cavity 30 through the water vapor conveying pipe 11 and the gas conveying pipe 13 respectively, so that the water vapor 14 fully contacts the gas to be processed 16 in the reaction cavity 30, and because the gas to be processed 16 at least contains the waste gas that could generate a reaction with the water vapor 14, that is, all or part of the gas to be processed 16 is the waste gas. Therefore, after the water vapor 14 contacts the gas to be processed 16, the water vapor 14 could react with the waste gas in the gas to be processed 16 to obtain the product 19. Moreover, with the negative pressure suction generated by the air extraction pump 60, the gas to be processed 17 obtained after reacting with the water vapor 14 and the product 19 obtained from a reaction could enter the introduction pipe column 24 through a top opening 24a of the introduction pipe column 24 of the condensation trap device 20, and are discharged from a bottom opening 24b of the introduction pipe column 24. Wherein, since the cooling element 28 could produce a condensation effect in the first cavity 22, the first cavity 22, the introduction pipe column 24 and the cooling element 28 are capable of generating condensation surfaces, so the gas to be processed 17 obtained after the gas to be processed 16 reacting with the water vapor 14 and a part of the product 19 produced after the above reaction are captured by the condensation capture processing (the first condensation capture processing), that is, the product 19 and part of components (such as oil gas or other exhaust gases) of the gas to be processed 17 obtained after reacting with the water vapor 14 are adsorbed and accumulated on the condensation surfaces of the first cavity 22, the introduction pipe column 24 and/or the cooling element 28 in the condensation trap device 20. Finally, after the gas to be processed 17 obtained after reacting with the water vapor 14 undergoes the condensation capture processing, a transport direction will be changed to move from a bottom side of the chamber 23 of the first cavity 22 (for example, reverse direction is from bottom to top, or turn to other directions) in order to perform the centrifugal separation processing on the gas to be processed 17, and the condensation trap device 20 is enabled to perform the condensation capture processing (second condensation capture processing) on the gas to be processed 17 again through an outer side of the introduction pipe column 24, such that a remaining part of the product carried by the gas to be processed could be captured. The gas to be processed 18 that has undergone the condensation capture processing and the centrifugal separation processing is discharged from the export pipe 26 located on the discharge port 22c of the first cavity 22.

If the waste gas contained in the gas to be processed 16 that could react with the water vapor 14 is trimethylaluminum (TMA), then trimethylaluminum (TMA) could react with the water vapor 14, and the product 19 obtained by a reaction is in the form of solid particles of aluminum hydroxide and/or aluminum oxide and gaseous methane, reaction formulas (1) and (2) are as follows:

$${Al ( {CH}_{3} )}_{3} + 3 {H}_{2} O {Al ( OH )}_{3} + 3 {CH}_{4} \qquad ( 1 )$$

$${Al ( {CH}_{3} )}_{3} + 3 / 2 {H}_{2} O 1 / 2 {Al}_{2} {O}_{3} + 3 {CH}_{4} \qquad ( 2 )$$

Through the above reaction formulas (1) and (2), a required water consumption per hour based on a flow rate of trimethylaluminum (TMA) in the disclosure could be calculated, thereby obtaining a better capture effect while maintaining a pumping speed, and capable of saving water resources in an environmentally friendly way. Taking trimethylaluminum (TMA) with a flow rate of 1.04 mol/hr as an example, a maximum water consumption of 3.12 mol/hr is required.

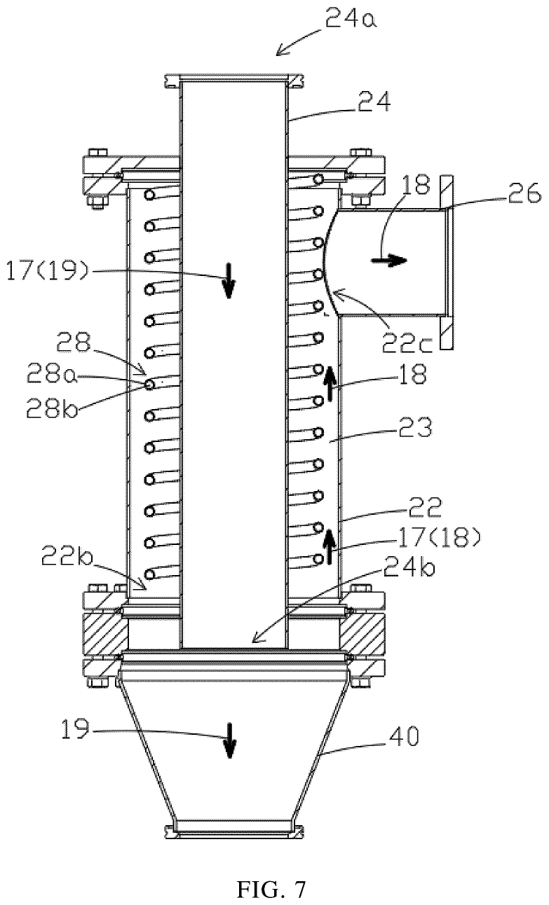

In the gas purification system 100 of the disclosure, the cooling element 28 of the condensation trap device 20 is not limited to a specific type, and it is not limited to internal cooling type or external cooling type; as long as a required condensation capture effect could be provided, any form of the cooling element 28 is applicable to the disclosure. For example, as shown in FIG. 7, the cooling element 28 comprises a hollow tube 28a and a condensing agent 28b, wherein the hollow tube 28a is spirally wrapping in the chamber 23 of the first cavity 22, and preferably wrapping the introduction pipe column 24, thereby not only providing condensation, but also serving as a baffle to prevent the product 19 from flowing upward to reach the discharge port 22c. In other words, a plurality of baffles 35 could be optionally added into the chamber 23 of the first cavity 22 of the disclosure, and the baffles 35 are, for example, distributed (e.g., staggered) on a side wall of the first cavity 22. The condensing agent 28b is located in the hollow tube 28a. The condensing agent 28b could be, for example, ice salt water, liquid nitrogen or ethylene glycol, or other fluids that could provide a cooling effect, and could be, for example, introduced into the hollow tube 28a from an inlet port 29a of the hollow tube 28a and exported from an exit port 29b. A number of the baffle 35 could be one or more than one, and the baffles 35 could optionally be inclined diversion baffles diagonally disposed on the side wall of the first cavity 22 (and/or a side wall of the introduction pipe column 24); for example, the baffles 35 extend from the side wall of the first cavity 22 (and/or the side wall of the introduction pipe column 24) toward an interior of the first cavity 22, and a inclination direction thereof is in the same as a flowing direction of the gas to be processed 16, 17 and/or 18. If the baffles 35 are provided, the baffles 35 could be distributed in a hierarchical and staggered manner. Taking the baffles 35 disposing on an inner side wall of the first cavity 22 as an example, the baffles 35 extend obliquely toward the interior of the first cavity 22, and an inclination direction of the baffles 35 is from a bottom of the first cavity 22 toward a top (for example, the discharge port 22c) of the first cavity 22, thereby providing efficacies of separating the product 19 and guiding an airflow at the same time. Taking the baffles 35 disposing on an inner side wall of the introduction pipe column 24 as an example, the baffles 35 extend obliquely toward the interior of the first cavity 22, and an inclination direction of the baffles 35 is from the top opening 24a of the introduction pipe column 24 toward the bottom opening 24b of the introduction pipe column 24, thereby providing efficacies of separating the product 19 and guiding an airflow at the same time. In addition, disposition or arrangement of the baffles 35 of the disclosure is not limited to the above examples, any disposition or arrangement of the baffles 35 capable of providing effects of separating the product 19 and/or guiding an airflow could be applied to the disclosure.

When the gas to be processed 16 contacts the water vapor 14, a reaction is produced to form the product 19, such as solid granular aluminum hydroxide and/or aluminum oxide and gaseous methane, of which most of the solid granular aluminum hydroxide and/or aluminum oxide will fall off directly due to the influence of gravity, and another part of the aluminum hydroxide and/or aluminum oxide and methane will be adsorbed on cooling surfaces inside the condensation trap device 20 (such as an inner side of the introduction pipe column 24). However, when the product 19 continues to be adsorbed on the cooling surfaces of the condensation trap device 20, such as surfaces of the chamber 23 of the first cavity 22, the introduction pipe column 24 and the cooling element 28, the excess product 19 will eventually be affected by gravity and fall off. In addition, the gas to be processed 17 undergone the condensation capture processing of the cooling surfaces inside the condensation trap device 20 will turn direction from the bottom side of the first cavity 22 and then float upward. Therefore, if the product 19 accompanying the gas to be processed 17 undergone the condensation capture processing is diverted (that is, the centrifugal separation processing), the product 19 will be thrown out due to the influence of centrifugal force. Therefore, another feature of the disclosure is that, in the collected product 19, aluminum hydroxide and/or aluminum oxide that falls off to the bottom side of the first cavity 22 accounts for about a majority (about 90% to 95%), and only a small amount (about 10% to 5%) of aluminum hydroxide and/or aluminum oxide and non-toxic gaseous methane will accompany the gas to be processed (i.e., the gas to be processed 17 undergone the condensation capture processing) to turn direction from the bottom side of the first cavity 22 and then float upward, and condense and adhere to a surface of the cooling element 28 or the first cavity 22. Therefore, the gas purification system 100 of the disclosure is additionally provided with the dust collection chamber 40, wherein the dust collection chamber 40 is disposed on the bottom side of the first cavity 22 of the condensation trap device 20, and a top side of the dust collection chamber 40 has an opening communicated with the chamber 23 of the first cavity 22 through the opening 22b on the bottom side of the first cavity 22 for collecting the product 19 thrown out by centrifugal force and/or dropped by gravity from the first cavity 22. The turning direction is, for example, changing the conveying direction by 180 degrees (reverse direction), but the disclosure is not limited thereto. Any angular degree of turning direction could be applied to the disclosure as long as it is conducive to centrifugal separation of the product 19.

In order to obtain a better collection effect, a contour of the dust collection chamber 40 is preferably a tapered chamber with a wide top and narrow bottom, but is not limited thereto. A bottom side of the dust collection chamber 40 could also have an opening, and a dust collection box 42 could be optionally added to the opening on the bottom side of the dust collection chamber 40, thereby collecting the product 19 falling off from the first cavity 22 due to gravity. Wherein the dust collection box 42 is preferably detachably disposed on the bottom side of the dust collection chamber 40 in order to clean the product 19 collected in the dust collection box 42, and for example, but is not limited to, using a double-grip caliper. In addition, as shown in FIGS. 1 to 3, a valve 41 could be optionally provided between the dust collection chamber 40 and the dust collection box 42 to control opening and closing of the opening on the bottom side of the dust collection chamber 40. For example, when cleaning the product 19 collected in the dust collection box 42, the opening on the bottom side of the dust collection chamber 40 could be temporarily closed by closing the valve 41, so it is not required to temporarily interrupt handling procedures of the gas to be processed when cleaning the captured product 19.

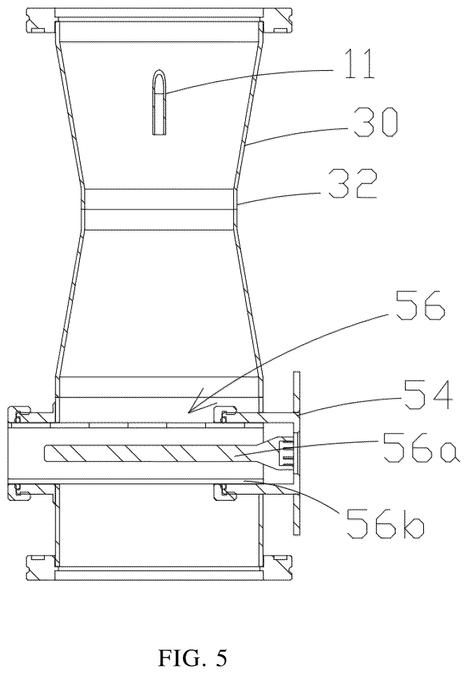

In a second embodiment of the disclosure, as shown in FIG. 1 and FIGS. 3 to 8, in addition to the structure shown in the first embodiment, the gas purification system 100 of the disclosure further comprises a microwave generator 50 disposing on the reaction cavity 30 to provide a microwave to assist the water vapor 14 to react with the gas to be processed 16 to produce the product 19. In detail, as shown in FIG. 5, the microwave generator 50 of the disclosure further comprises a microwave generating source 54 and a waveguide 56, wherein the microwave generating source 54 is used to generate the microwave to be introduced into the reaction cavity 30 through the waveguide 56, and the microwave is used to assist mixing and reaction between the water vapor 14 and the gas to be processed 16 to produce the corresponding product 19. Wherein the microwave generating source 54 and the waveguide 56 are disposed on the reaction cavity 30, and are, for example, transversely and penetratingly disposed on the reaction cavity 30 to generate the microwave in the reaction cavity 30. The microwave generating source 54 is, for example, a magnetron, and the waveguide 56 is, for example, provided at an antenna output end of the magnetron, for guiding the microwave generated by the microwave generating source 54 to the interior of the reaction cavity 30. Wherein a structure of the waveguide 56 could, for example, comprise a metal rod 56a and a quartz tube 56b surrounding the metal rod 56a at a spacing, but it is not limited thereto. In addition, the waveguide 56 could also be provided with a microwave matcher 56c that is transversely connected to the metal rod 56a to adjust a reflection amount of the microwave, thereby effectively introducing the microwave into the reaction cavity 30. Microwave frequency and wavelength range generated by the disclosure are not particularly limited; they could be, for example, 2.45 GHz and 12.24 cm commonly used in household microwave ovens, or other numerical values, as long as they could be used to assist a reaction between the water vapor 14 and the gas to be processed 16, they could be applied to the disclosure.

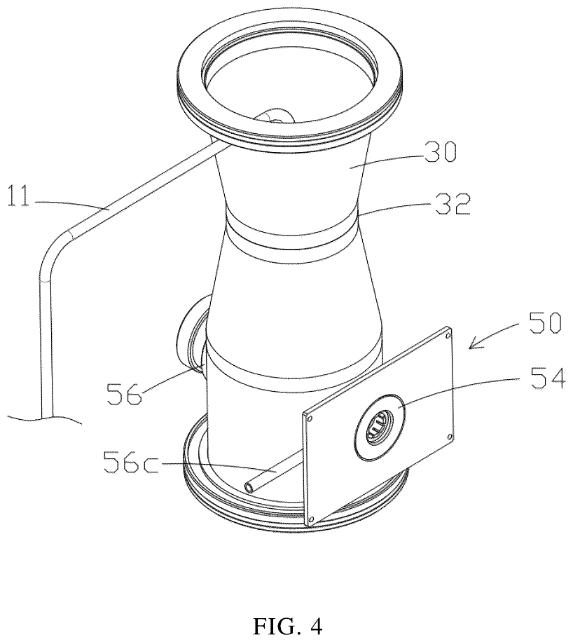

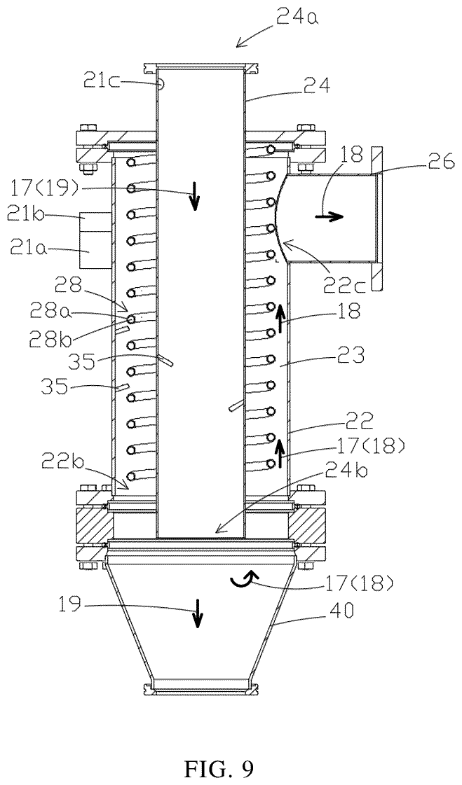

In the first and second embodiments of the disclosure, the reaction cavity 30 could be, for example, a hollow column, and pipe diameters of the reaction cavity 30 from a top side to a bottom side could be the same (i.e., tube with a same diameter throughout) or different (i.e., tube with different diameters). In addition, an internal contour of the reaction cavity 30 is not limited to a vertical shape, for example, it could also be spiral or inclined, or for example, the gas to be processed 16 could be introduced into the reaction cavity 30 obliquely, so that, for example, a vortex airflow is generated in the reaction cavity 30, and for example, a vortex airflow is generated in the first cavity 22 of the condensation trap device 20, thereby effectively concentrating the product 19 in the dust collection chamber 40 through centrifugal force, and preventing the product 19 from being discharged from the discharge port 22c. However, the disclosure is not limited to causing the gas to be processed 16 to form a vortex airflow. The disclosure could also use various airflow patterns to cause the gas to be processed 16 to be performed with the condensation capture processing in the condensation trap device 20. In addition, as shown in FIGS. 4 to 6, the reaction cavity 30 could optionally have a neck area 32 inside, wherein a pipe diameter of the neck area 32 is smaller than that of other areas. For example, the reaction cavity 30 could be formed by gradually reducing a pipe diameter from the top side and the bottom side toward a middle section to form a hollow column in the neck area 32. Wherein the microwave generated by the microwave generating source 54 is introduced into an area below the neck area 32 of the reaction cavity 30 through the waveguide 56, for example. Moreover, according to fluid mechanics, the neck area 32 further helps to drive the product 19 obtained from a reaction to leave the reaction cavity 30 quickly. Similarly, the introduction pipe column 24 could also be a hollow pipe column, for example, wherein pipe diameters of the hollow pipe column of the introduction pipe column 24 from a top side to a bottom side could be the same (i.e., tube with a same diameter throughout) or different (i.e., tube with different diameters). Moreover, the introduction pipe column 24 of the disclosure being vertical and being a hollow pipe column of a same pipe diameter is used as an example; however, a contour of the introduction pipe column 24 of the disclosure is not limited to a vertical shape, it could also be a spiral shape, for example, thereby generating a vortex airflow in the introduction pipe column 24; or an inclined shape, thereby generating a vortex airflow in the first cavity 22 and/or the introduction pipe column 24, so that the product 19 could be effectively concentrated in the dust collection chamber 40 through centrifugal force to prevent the product 19 of solid particles from being discharged from the discharge port 22c. The condensation trap device 20 of the disclosure could also optionally be provided with a vibrator 21a disposed on the first cavity 22 (as shown in FIG. 9), the introduction pipe column 24 and/or the cooling element 28, wherein when a pumping speed of the gas to be processed 16 decreases or a capture effect of the gas to be processed 16 decreases, a user could manually start the vibrator 21a, or an external controller 21b could, for example, receive a sensing signal of an airflow detector 21c and generate an operation command, thereby the vibrator 21a generating vibration according to the operation command to shake off the product 19 adsorbed on the first cavity 22, the introduction pipe column 24 and/or the cooling element 28, thereby restoring an original pumping speed or capture effect. In addition, although the disclosure takes the reaction cavity 30 and the first cavity 22 as independent components as an example, the disclosure is not limited thereto. The reaction cavity 30 of the disclosure could also be integrated with the first cavity 22.

In addition, the water vapor conveying pipe 11 used in the disclosure preferably has at least one flow control valve 15, and the flow control valve 15 is capable of adjusting a volume of the water vapor 14 to be delivered through the water vapor conveying pipe 11 to the interior of the reaction cavity 30 by controlling an opening angle. Moreover, an opening angle of the flow control valve 15 corresponds to a flow rate of the waste gas in the gas to be processed 16, that is, if a flow rate of the waste gas in the gas to be processed 16 increases, an opening angle of the flow control valve 15 increases, thereby providing a larger amount of the water vapor 14. In other words, the disclosure could adopt a suitable opening angle of the flow control valve 15, for example, between 75 degrees and 90 degrees, and preferably about 75 degrees (wherein 0 degree means a valve is closed), according to a flow rate of the waste gas in the gas to be processed 16, this could not only achieve a better capture effect while maintaining a pumping speed of the gas to be processed 16, but also save water resources in an environmentally friendly manner. For example, when the waste gas is trimethylaluminum, a flow rate of trimethylaluminum is about 75 g/hr, and a pumping speed is about 24,000 L/s to 25,160 L/s, the disclosure could control a usage amount of the aqueous solution 12 within 75 g/hr˜135 g/hr, and its total capture rate could reach 39%. Wherein the flow control valve 15 could be, for example, a manual ball valve 15a and/or a pneumatic valve 15b. Similarly, in the disclosure, pipe diameter and length of the first cavity 22 of the condensation trap device 20 correspond to a pumping speed of the air extraction pump 60, that is, the larger a pipe diameter, the higher a pumping speed that could be achieved; the longer a length, the lower a pumping speed that could be achieved. Therefore, the disclosure could also correspondingly use the first cavity 22 with appropriate pipe diameter and length according to a pumping speed of the air extraction pump 60, thereby obtaining a better capture effect while maintaining a pumping speed of the gas to be processed 16, for example, a capture rate could be as high as 39.9%. In other words, the disclosure could further optionally connect the gas purification systems 100 in series, parallel or a combination thereof, thereby effectively improving a capture rate. Taking series connection as an example, the export pipe 26 of the previous gas purification system 100 is connected to an inlet of the reaction cavity 30 of the next gas purification system 100, and so on. Taking parallel connection as an example, inlets of the reaction cavities 30 of the gas purification systems 100 are jointly connected to the gas to be processed generation source 70, and the export pipes 26 are jointly connected to the air extraction pump 60.

In addition, since the disclosure utilizes vaporization effects such as boiling or evaporation of the aqueous solution 12 to form the water vapor 14, and preferably could accelerate vaporization of the aqueous solution 12 to form the water vapor 14 through a low-pressure environment, the discharge port 22c of the first cavity 22 of the condensation trap device 20 is communicated to the air extraction pump 60 that could generate the negative pressure suction. In addition, the water tank 10 could also optionally be provided with a heating element 62, which is, for example, a sheathed heater for liquid heating, for heating the aqueous solution 12 in the water tank 10 to a preset temperature. The preset temperature is, for example, below about 40 degrees Celsius, preferably between about 30 degrees Celsius and 40 degrees Celsius. Moreover, the preset temperature preferably corresponds to a flow rate of the waste gas in the gas to be processed 16, that is, if a flow rate of the waste gas in the gas to be processed 16 is higher, a numerical value of the preset temperature is also higher, thereby providing a larger amount of the water vapor 14. For the same reason, the water tank 10 could optionally be provided with a temperature sensor 64 and a temperature regulator 66. Wherein the temperature sensor 64 is, for example, a thermocouple for detecting a temperature of the aqueous solution 12, and the temperature regulator 66 could receive a sensing signal of the temperature sensor 64 and control an operation of the heating element 62, so that a temperature of the aqueous solution 12 reaches the preset temperature and is maintained at the preset temperature.

In addition, the water tank 10 could also optionally be provided with a vent pipe fitting 67, an outlet thereof is located in the water tank 10, and has a vent valve to optionally balance pressures between the water tank 10/the reaction cavity 30 and an external environment, which is the so-called vacuum breaking. In addition, the disclosure could optionally introduce a nitrogen gas through the vent pipe fitting 67 to balance pressures between the water tank 10/the reaction cavity 30 and an external environment. The nitrogen gas could also be used to provide a dilution effect to prevent possible combustion of gases in the product 19 during maintenance or processing. Wherein the water tank 10 further optionally comprises a water level gauge 68 that could be used to display a liquid level height of the aqueous solution 12. Wherein the water level gauge 68 is, for example, a transparent observation tube with two ends communicated to an interior of the water tank 10 respectively. The water level gauge 68 uses the principle of a communicating tube to cause a height of the aqueous solution 12 inside the water tank 10 the same as a height of the aqueous solution 12 in the transparent observation tube, so a liquid level height of the aqueous solution 12 could be observed. Moreover, the disclosure further enlarges a tube diameter of the transparent observation tube, and preferably makes a tube diameter of the transparent observation tube larger than about 25 mm, thereby when the aqueous solution 12 boils, preventing bubbles generated from clogging the transparent observation tube and causing a false water level phenomenon, which affects water level judgment. In addition, since the product 19 produced by a reaction between the water vapor 14 and the gas to be processed 16 is dust-like solid particles; in order to immediately observe whether the condensation trap device 20 is blocked by the product 19, a cavity wall of the first cavity 22 of the condensation trap device 20 of the disclosure could be optionally provided with an observation window 69 for a user to observe a status of the chamber 23 of the first cavity 22 in real time. In addition, a tank body 10a of the water tank 10 could be provided with a fixed or detachable cover 10b, and a drainage pipeline 10c with a water valve could be optionally added at a bottom of the water tank 10 to optionally discharge the aqueous solution 12 in the water tank 10.

Based on the above, the gas purification system of the disclosure has the following advantages. (1) The gas purification system is provided with the reaction cavity that enables the water vapor to react with the gas to be processed to produce the corresponding product. (2) The gas purification system is provided with the condensation trap device capable of capturing the product produced by a reaction between the water vapor and the gas to be processed. (3) The gas purification system is provided with a dust collection chamber capable of collecting the product thrown out by centrifugal force and/or dropped by gravity. (4) The gas purification system is provided with a dust collection box capable of collecting the product. (5) The gas purification system is provided with a microwave generator capable of providing a microwave to assist a reaction between the water vapor and the gas to be processed, and capable of providing an effect of maintaining temperature to prevent premature condensation of the water vapor on a pipe wall. (6) The gas purification system is provided with a flow control valve capable of controlling a supply volume of the water vapor of a water vapor conveying pipe to correspond to a flow rate of the gas to be processed, so that the aqueous solution could be used most efficiently. (7) The gas purification system is provided with a heating element capable of controlling a temperature of the aqueous solution in the water tank to correspond to a flow rate of the gas to be processed, so that the aqueous solution could be used most efficiently. (8) The disclosure could not only effectively process the gas to be processed, but could also reduce an energy consumption of mechanical pumps and significantly reduce a production volume of greenhouse gases such as nitrogen oxides (NOx), at the same time, could effectively solve the problem of solid particle clogging to extend a service life of dry pumps.

Note that the specification relating to the above embodiments should be construed as exemplary rather than as limitative of the present disclosure, with many variations and modifications being readily attainable by a person of average skill in the art without departing from the spirit or scope thereof as defined by the appended claims and their legal equivalents.

What is claimed is:

1. A gas purification system, the gas purification system performing a condensation capture processing and a centrifugal separation processing on a waste gas in a gas to be processed, thereby purifying the gas to be processed, the gas purification system at least comprising:
a water tank storing an aqueous solution used to generate a water vapor;
a reaction cavity using a negative pressure suction to transport the water vapor and the gas to be processed in the water tank into the reaction cavity, so that the water vapor contacting the waste gas in the gas to be processed and performing a reaction to obtain at least one product; and
a condensation trap device communicated to the reaction cavity, the condensation trap device enabling the gas to be processed to enter the condensation trap device along a transport direction, thereby performing the condensation capture processing to capture a part of the product carried by the gas to be processed, and then the transport direction of the gas to be processed being changed, so that a remaining part of the product carried by the gas to be processed being captured by performing the centrifugal separation processing and the condensation capture processing again, and then the gas to be processed undergone the condensation capture processing and the centrifugal separation processing of the condensation trap device being discharged.

2. The gas purification system as claimed in claim 1, further comprising a microwave generator for providing a microwave to assist generating of the reaction between the water vapor and the waste gas in the gas to be processed to obtain the product.

3. The gas purification system as claimed in claim 2, wherein the microwave generator uses a microwave generating source to generate the microwave and introduces the microwave into the reaction cavity through a waveguide.

4. The gas purification system as claimed in claim 3, wherein the waveguide further comprises a microwave matcher capable of adjusting a reflection amount of the microwave to introduce the microwave into the reaction cavity.

5. The gas purification system as claimed in claim 1, wherein the water vapor is transported from the water tank into the reaction cavity through a water vapor conveying pipe, and the gas to be processed is transported from a gas to be processed generation source into the reaction cavity through a gas conveying pipe.

6. The gas purification system as claimed in claim 5, wherein the water vapor conveying pipe is provided with a flow control valve, and an opening angle of the flow control valve corresponds to a flow rate of the waste gas in the gas to be processed, thereby capturing the product while maintaining a pumping speed of the gas to be processed.

7. The gas purification system as claimed in claim 6, wherein the water tank is provided with a heating element for heating the aqueous solution in the water tank to a preset temperature, and the preset temperature corresponds to a flow rate of the waste gas in the gas to be processed, thereby capturing the product while maintaining a pumping speed of the gas to be processed.

8. The gas purification system as claimed in claim 1, wherein the condensation trap device comprises: a first cavity; an introduction pipe column penetratingly disposed in a chamber of the first cavity through a top side of the first cavity, and extending in a direction toward an opening on a bottom side of the first cavity, the chamber of the first cavity is communicated to the reaction cavity through the introduction pipe column; an export pipe disposed on a discharge port of the first cavity; and a cooling element disposed on the chamber of the first cavity for performing the condensation capture processing and the centrifugal separation processing on the product flowing through the condensation trap device, and then the gas to be processed undergone the condensation capture processing and the centrifugal separation processing of the condensation trap device is discharged through the discharge port.

9. The gas purification system as claimed in claim 8, wherein the discharge port of the first cavity of the condensation trap device is communicated to an air extraction pump capable of generating the negative pressure suction.

10. The gas purification system as claimed in claim 9, wherein a pipe diameter and a length of the first cavity correspond to a pumping speed of the air extraction pump, thereby capturing the product while maintaining a pumping speed of the gas to be processed.

11. The gas purification system as claimed in claim 8, wherein the cooling element comprises a hollow tube spirally wrapping in the chamber of the first cavity and a condensing agent located in the hollow tube.

12. The gas purification system as claimed in claim 8, wherein the first cavity of the condensation trap device is further provided with an observation window thereon for observing the chamber of the first cavity.

13. The gas purification system as claimed in claim 1, wherein the water tank further comprises a water level gauge for displaying a height of the aqueous solution.

14. The gas purification system as claimed in claim 1, wherein the waste gas contained in the gas to be processed is trimethylaluminum (TMA), and the product is aluminum hydroxide and/or aluminum oxide.

15. The gas purification system as claimed in claim 1, further comprising a dust collection chamber communicated to a bottom side of the condensation trap device for collecting the product thrown out by centrifugal force and/or dropped by gravity.

16. The gas purification system as claimed in claim 15, wherein the dust collection chamber has an opening on a bottom side thereof, and the dust collection chamber has a dust collection box disposed on the opening on the bottom side of the dust collection chamber.

17. The gas purification system as claimed in claim 16, wherein the dust collection chamber further has a valve disposed between the bottom side of the dust collection chamber and the dust collection box.

18. The gas purification system as claimed in claim 16, wherein the dust collection chamber is a tapered chamber.

19. The gas purification system as claimed in claim 1, wherein the reaction cavity is a vertical, an inclined or a spiral hollow column.

20. The gas purification system as claimed in claim 19, wherein the reaction cavity has a neck area, and a pipe diameter of the neck area is smaller than that of other areas of the reaction cavity.

21. The gas purification system as claimed in claim 1, wherein the gas to be processed forms a vortex airflow in the condensation trap device to perform the condensation capture processing.

22. The gas purification system as claimed in claim 1, wherein the condensation trap device is provided with a vibrator for shaking off the product adsorbed on the condensation trap device.
